(19) United States
(12) Patent Application Publication
(10) Pub. No.: US 2006/0020803 A1
(43) Pub. Date: Jan. 26, 2006

(54) Systems and methods for authentication of items or documents

(75) Inventor: James Joseph O'Hagan, McHenry, IL (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: ZIH Corp., Hamilton (BM)

(21) Appl. No.: 11/091,298

(22) Filed: Mar. 28, 2005

Related U.S. Application Data
(60) Provisional application No. 60/585,612, filed on Jul. 6, 2004.

(51) Int. Cl. H04L 9/00

(52) U.S. Cl. 713/176

(57) ABSTRACT

Systems and methods for securing documents combine a physical document characteristic with variable information to form an authentication key. The key can be applied to the document along with the variable information. Subsequently, the document can be authenticated by re-reading the characteristic and variable information present on the document, forming another representation of the authentication key and comparing same to the authentication key carried by the document.

### CROSS REFERENCE TO RELATED APPLICATIONS

This application claims the benefit of the filing date of U.S. provisional application No. 60/585,612 filed Jul. 6, 2004 and entitled “Systems and Methods for Authentication of Documents”.

### FIELD OF THE INVENTION

The invention pertains to systems and methods usable to authenticate documents. More particularly, the invention pertains to systems and methods which can be used to make documents self-authenticating.

### BACKGROUND OF THE INVENTION

Numerous types of documents are targets of attempted duplication and/or modification. Currency counterfeiters present well known and long term problems in this regard. Other types of documents such as identification documents, product designation documents, documents of value such as airline tickets, transit tickets, packaging and the like are all potential targets of improper modification. Packaging can include shipping labels, model plates, government required compliance labeling, care instructions on a label or hang tag, all without limitation.

A variety of techniques are known to try to minimize the likelihood of successful counterfeiting or modification. However, while known techniques may be useful and effective in certain circumstances, none of them are known to be full proof.

There continues to be an ongoing need for systems and methods of securing documents of various types. Preferably, such systems and methods could be used cost effectively with a wide variety of documents and would not be limited to documents of high intrinsic value. Also preferably, such systems and methods can be configured so as to provide multiple levels of security encompassing both the authenticity of the document as well as the authenticity of the information carried on a particular document.

### SUMMARY OF THE INVENTION

A method of providing an authenticable item or document includes obtaining variable information for the item or document. A physical characteristics of an item can be sensed. A physical characteristic of a blank for the document can be sensed. At least some of the variable information is combined with a representation of at least a portion of the scanned physical characteristic to form an authentication element. The authentication element and at least part of the variable information are incorporated into the item or the blank to at least partly form the document.

### BRIEF DESCRIPTION OF THE DRAWINGS

FIG. 1 is a block diagram of a printer in accordance with the invention;

FIG. 1A is a representative document in accordance with the invention;

FIG. 2 is a block diagram of a reader in accordance with the present invention;

FIG. 3 is a method of securing a document in accordance with the invention;

FIG. 4 is a method of evaluating authenticity of a document in accordance with the invention;

FIG. 5 is yet another method in accordance with the invention.

### DETAILED DESCRIPTION OF THE EMBODIMENTS

While embodiments of this invention can take many different forms, specific embodiments thereof are shown in the drawings and will be described herein in detail with the understanding that the present disclosure is to be considered as an exemplification of the principles of the invention and is not intended to limit the invention to the specific embodiment illustrated.

Systems and methods in accordance with the invention can be used to implement brand protection programs. Such programs seek to counteract product counterfeiting as well as product diversion. Alternately, systems and methods in accordance with the invention can be used to implement multi-level medium, item, or, document and information authentication programs.

In one embodiment, an output device can incorporate a sensor or scanner of a physical characteristic of an item or a document such as a magnetic characteristic, a translucent characteristic, a fluorescent characteristic, a reflective characteristic, or an RF activated characteristic all without limitation. Sensing or scanning the physical characteristic produces a unique, item or document specific, signature that is unaltered by normal use of the respective item or document.

The output device can also, optionally incorporate a scanner of images or information which are either carried in some fashion on an item or a document or can be obtained from another source. The output device can include circuitry, including for example, a programmable processor, to combine the item or document characteristic information, the item or document signature, with selected variable information associated with the item or document to produce an authentication key. Processing can include hashing, encryption or encoding all without limitation. In a disclosed embodiment, the output device can include a printer to apply the key to the item or document.

The authentication key along with additional information can be applied to or printed on the item or document using any convenient technology such as thermal, optical or ink-based methodologies. Graphics can be combined with the authentication key and other information on the item or document. Alternately, a radio frequency responsive identification (RFID) tag can be embedded into the item or document. The signature can be encoded into the RFID tag for later retrieval.

In another aspect of the invention, the authenticity of an item or document can be evaluated. The document characteristic or signature of a given item or document can be read or sensed. Information carried on the document including a previously applied authentication key can be read or sensed. The information from the document can be combined with the respective signature information to provide a current authentication key.

The authentication key read from the item or document can be compared to the current authentication key. Where the two keys are substantially identical, the item or document can be regarded as authentic.

In yet another aspect of the invention, an authentic document can be processed further by reading or sensing the variable information carried by the document as well as the authentication key. Some or all of that information can be compared to information retrieved from a secure database to establish that the authentication information, and/or the variable information has been properly associated with the documents.

In another embodiment, a reader which embodies the invention, can incorporate control circuitry coupled to a document signature or characteristic scanner as well as a document information or image scanner. A document can be authenticated by exposing it to the scanners in the reader. The reader in turn processes the information obtained from the document to produce a current authentication key.

The current authentication key can be compared to an authentication key previously applied to or stored on the document. The authentication key can incorporate not only the document signature, but also at least some of the variable information carried by the document, all without limitation.

Document signature sensors or readers can be magnetic or optical without limitation. Sensors of other types of information could also be magnetic or optical.

In a brand protection embodiment of the invention, systems and methods can be provided for use with various types of security media, such as security paper for currency, bank note paper or other uses. In this embodiment, a designator for a product such as discrete sheets, or, a roll of the medium can be entered and a signature for label stock read and combined (by encoding, encrypting, hashing) with the roll designator so as to produce a label based authentication key. The key can be recorded on the label which in turn can be attached to the medium for subsequent authentication and tracking.

The label carried on the medium can be subsequently scanned at various points in the supply chain. The signature of the label can be sensed as well as other information thereon concerning the medium that carries the label. The label's signature and the other information thereon can be encoded, hashed or encrypted as required, all without limitation, to establish a current authentication key. This key can be compared to an authentication key carried on the label. Where the authentication key carried on the label is substantially identical to the current authentication key, a conclusion can be drawn that the medium is authentic.

A method in accordance with the invention includes reading or sensing a physical characteristic of an item or document, producing a signature, combining the signature with other information specific to the document to produce an authentication key. The authentication key as well as the item or document specific information can be printed on or permanently affixed to the document.

An authentication method includes sensing the signature of the item or document as well as other information carried by the item or document and combining same to form a current authentication key. The current authentication key can be compared to an authentication key carried on the item or document. An authentic item or document can be expected to exhibit an authentication key which is substantially identical to the current authentication key. The other information carried on an authentic item or document can be subsequently compared to data from a secure database to confirm that not only is the item or document itself authentic, but that it has been properly issued.

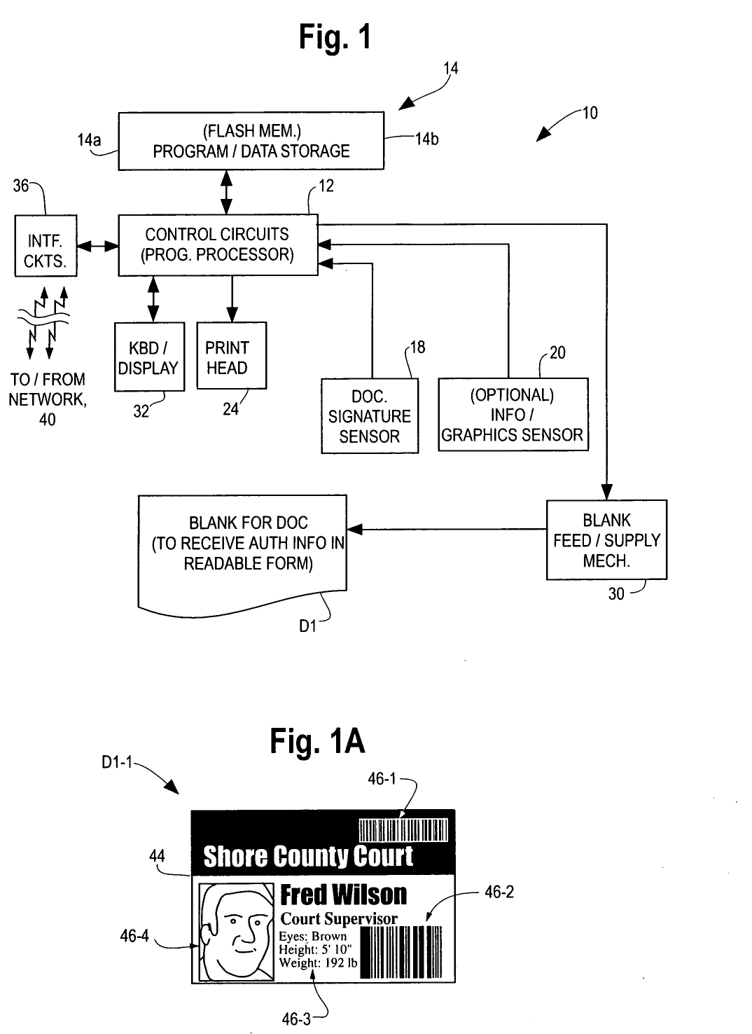

FIG. 1 illustrates a printer 10 in accordance with the present invention. The printer 10 incorporates control circuitry, which might include a programmable processor 12, coupled to storage 14 which might incorporate programmable read-only memory, such as flash memory 14a for substantially permanent storage of control programs as well as read/write memory 14b for data storage.

The control circuitry 12 receives signals from a document characteristic sensor 18. The sensor 18 could sense magnetic, optical or RFID tags. It can also receive signals from a document image or information sensor 20, which could be magnetic, optical or RF.

The control circuits 12 are additionally coupled to a print head 24 for applying or printing, information to or on a subject document. The print head 24 can be implemented with a variety of technologies including, optical, thermal or mechanical printing, all without limitation. In addition, as an alternate, any type of transducer which could in some way couple information to an item or document could be used, for example, signals could be used to write to an RFID-type tag.

Control circuitry 12 is also coupled to document feed/supply mechanism 30 which can be configured to supply labels, cards, sheets, tickets, tags or the like, all without limitation to receive information from print head 24. Control circuitry 12 can also be coupled to a keyboard/display element 32 which can be used for bi-directional communication with an operator. Additionally, control circuitry 12 can be in bi-directional communication with remote processors or systems via interface circuitry 36 and one or more computer networks 40.

Printer 10 can be used to associate authentication information with a document D1 from the document feed/supply element 30. It will be understood that the exact nature and characteristics of the document D1 are not limitations of the present invention. Nor, are the characteristics or structure of the document feed/supply element 30 limitations of the present invention.

FIG. 1A illustrates an exemplary document D1-1 which could be prepared using printer 10. Document D1-1 has a planar base member 44 which might be fed via supply element 30. Base number 44 carries a unique signature providing characteristic in region 46-1.

While visible for exemplary purposes in FIG. 1A, the characteristic in region 46-1 could be invisible. It could be formed as an optical element, for example a bar coded but invisibly printed signature. It could be formed as an embedded magnetic thread(s) or a deposited magnetic layer without limitation. Other types of characteristics could be used without limitation including RFID-type tags.

Region 46-2 carries a machine readable 2 dimensional bar code. The bar coded information includes an authentication key applied by printer 10. It might also include bar coded versions of other information 46-3 printed on base member 44 in human readable form by printer 10.

The other information 46-3 can be supplied to printer 10 via network 40 and circuits 36. Alternately, it can be supplied from another document (using sesnor 20). A representation of a photograph 46-4 (applied by printer 10) can also be included in region 46-2 and used as described subsequently for authentication.

As discussed in more detail subsequently, control circuits 12 in combination with the control program prestored in memory 14a can sense both an inherent characteristic of document D1, the document's signature, using sensor 18 as well as variable information associated or to be associated with document D1 via sensor 20. It will be understood that the source of the variable information to be associated with document D1 could include document D1 itself, other documents, local or displaced databases, or a local input device such as a keyboard 32 all without limitation.

The control program and circuits 12 can in turn combine the document characteristic or signature with variable information to produce an authentication key to be applied to document D1, via print head 24, in combination with other variable information to be associated with document D1. The way in which the document signature is combined with other information to be associated with or placed on the respective document is not a limitation of the invention. For example, a checksum can be created for use as a key. Other types of encoding, encryption or hashing can be used without limitation.

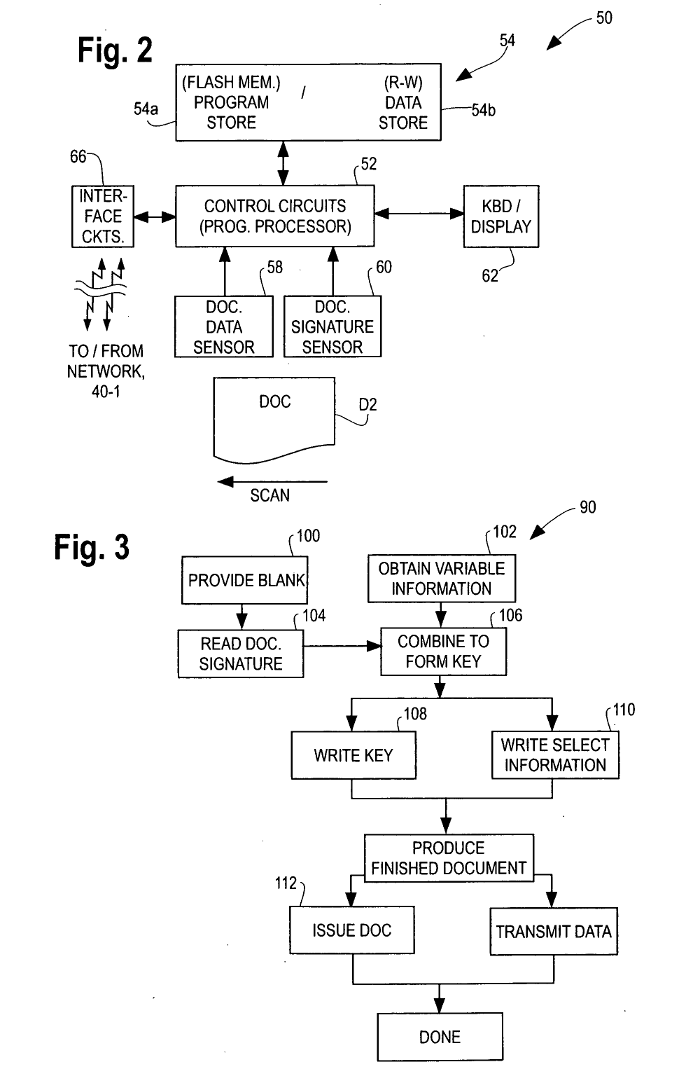

FIG. 2 is a block diagram of a reader 50 which can be used to determine the authenticity of documents such as the document D1 or D1-1. The reader 50 can include control circuitry 52, which could include a programmable processor and one or more storage elements indicated generally at 54. The storage elements 54 can include program storage such as programmable read-only memory 54a as well as read/write memory for data storage 54b. Those of skill in the art will understand that the type of storage elements 14a, 14b, 54a, 54b are not limitations of the present invention.

The reader 50 can also include a magnetic, optical or RF-type data sensor 58 as well as a magnetic, optical, or RF-type document characteristic sensor 60. The reader 50 can also include a keyboard/display element 62 in order to provide bi-directional communication between control circuits 52 and a user. The element 62 could be implemented as a simple switch combination and binary output such as a visual or audible output device if desired. Additionally, the reader 50 can incorporate interface circuits 66 so as to place the reader 50 in the bi-directional communication via one or more computer networks 40-1 with displaced processors or systems, as desired.

The reader 50 can be used to authenticate a document such as document D2 (or D1-1) by sensing a document characteristic, using sensor 60, as well as sensing information carried on document D2 via sensor 58. Control circuitry 52 in combination with the prestored control program can process the sensed information to form a current authentication key.

The current authentication key formed by control circuitry 52 can be compared to an authentication key precorded on document D2, or such as in region 46-2 of document D1-1. Substantial identity between the two keys leads to a conclusion that document D2, or D1-1, is authentic.

Subsequently, control circuitry 52 can transmit sensed information to or receive additional information from one or more remote databases, via network 40-1 and interface circuitry 66 to determine that document D2 has been either properly issued or not modified. For example, had document D2 been stolen and improperly processed to form a counterfeit, it might appear to be an authentic document until information from a remote database was examined. Such information could confirm, for example, that document D1-1 had never been properly issued. Alternately, document D1-1 could have been modified to carry a different photograph, and be otherwise authentic. In this instance, the modified photograph could be detected using information from a remote database indicative of the original photograph.

FIG. 3 illustrates an exemplary method 90 in accordance with the invention. In a step 100 a blank is provided. In a step 102 information for a document is obtained. The information could be already present on the document or it could be obtained elsewhere, for example from a database. The information 102 is variable information which is application or document-type dependent.

In a step 104 a physical characteristic, the document signature, is read or sensed off the document. In a step 106 the variable information, at least in part, is combined by encoding, encryption, hashing or the like with the document signature to form an authentication key. In a step 108 the authentication key is written to the document. In step 110 other information and/or graphics can be written to the document. The document can then be issued, step 112.

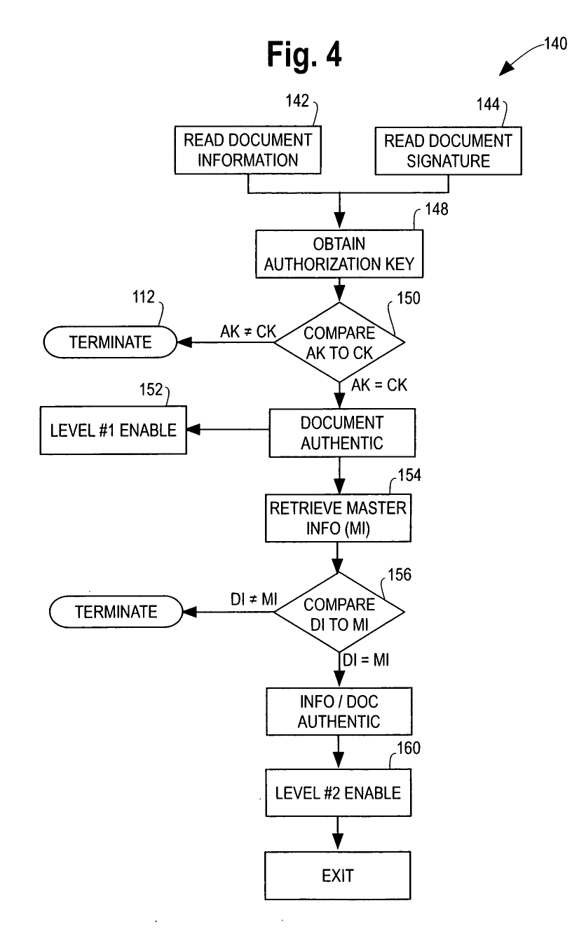

FIG. 4 illustrates an exemplary authentication process 140 in accordance with the invention. In an initial step 142, pre-stored information (region 46-2) is sensed or read off of a subject document. In a step 144 the document signature (region 46-1) is read from the document.

In a step 146 a previously created authentication key is obtained either directly from the document, (pre-stored information region 46-2) or from previously read document information step 142. In a step 148 selected document information is combined with the document signature information to create a current key. In a step 150, the current key is compared to the previously created authentication key.

Where the current key is substantially identical to the authentication key, the document can be regarded as authentic. Level 1 functions can be enabled at this time, step 152.

Where an additional level of authentication is required or desired, master information can be obtained from a secure source, such as a remote database as in step 154. In a step 156 some or all of the other document information can be compared to the master information. Where the document information is substantially identical to the master information, a conclusion can be drawn that the proper information is present on an authenticated document. In this instance, functions associated with a second level of authentication can be enabled, step 160. It will be understood that variations of methods 100 or 140 come within the spirit and scope of the invention.

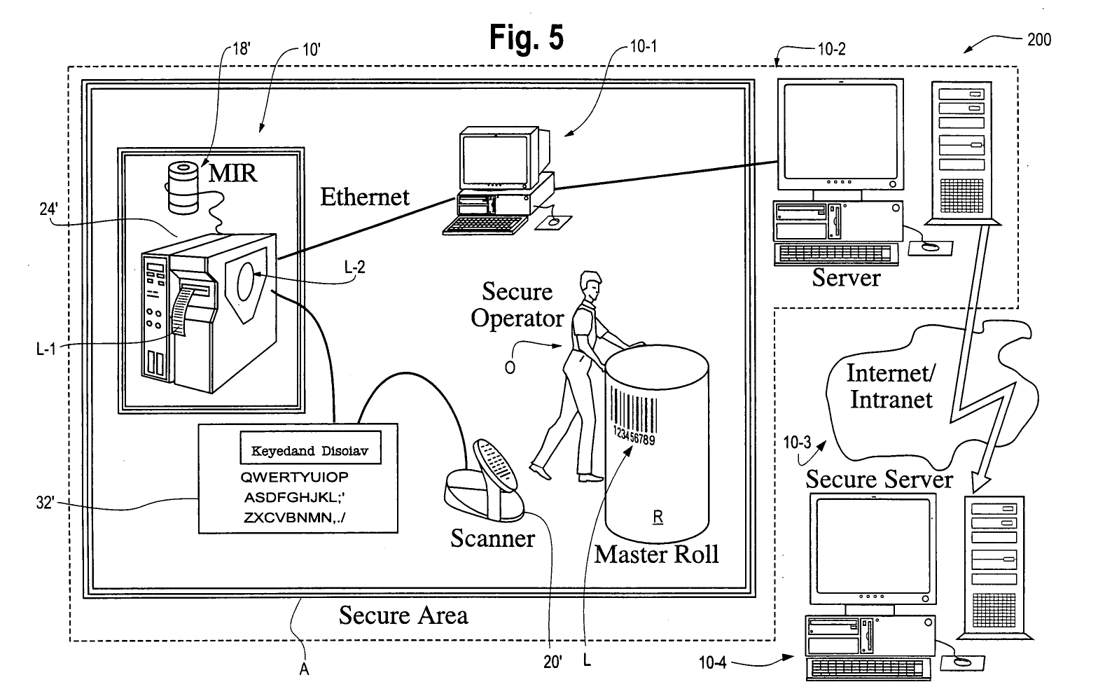

FIG. 5 illustrates an exemplary method 200 in accordance with the invention. In the method of FIG. 5, a printer 10′ comparable to the printer 10 of FIG. 1, is used to provide authenticatable labels for master rolls of security paper, such as the representative roll R. The method 200 could be used, for example as part of a Product, or Brand Protection program. The method 200, or variations thereof could be used in connection with creating labels for other types of products, tickets, bank notes, or other documents of value without limitation.

In the method 200, an operator O, in a secure area A, using a bar code scanner 20′ scans an existing bar code label L on the master roll R. The bar coded information is in turn coupled to a printer 10′.

The printer 10′ prepares a secure, authenticatable label L-1 (from roll L-2) which can be affixed to the roll R for the purpose of tracking the roll R through the supply chain and to authenticate roll R at any point within the supply chain. It will be understood that the security paper of the roll R could be, for example, bank notes or thermal transfer paper without limitation. Instead of rolls, discrete sheets could be used.

The label blanks of roll L-2 each include a unique magnetic signature region. In the exemplary process 200, the magnetic security region, for each blank, is formed of embedded magnetic thread(s). Deposited optical or magnetic material, optical or RF-type document characteristics could also be used.

The printer 10′ incorporates a reader 18′ of magnetic threads embedded in the label stock indicated generally at L-2 and carried on a roll within the printer 10′. The printer 10′ combines a document signature for a label L-1 read by reader 18′ with bar code information L read off of roll R to produce an authentication key which can be printed on the L-1 along with the bar code L and other variable information pertaining to the application.

The printer 10′ can couple information concerning label L-1 via a local area network to a processor 10-1 which is coupled to a local server 10-2 out of the secured area A. The server 10-2 can be in communication, via a computer network such as an internet or intranet 10-3 which is also outside of the secure area A, with a remote secure server 10-4. Relevant information can be decrypted and stored at server 10-4.

The printed label L-1 containing the authentication key can be affixed to the master roll R for tracking and for authenticating the roll R subsequently downstream in the supply chain. It will be understood that the server 10-4 could be in communication subsequently with a recipient of the roll R. That recipient can use the previously discussed reader 50 for purposes of authenticating the label L-1.

It will be understood that processor 10-1 could encrypt information received from printer 10′ prior to forwarding same to server 10-2 (insuring that any information transmitted from secure area A is previously encoded or encrypted). This configuration has the advantage that server 10-2 need not be a secure server since it is only providing communication capabilities to displaced secure server 10-4.

Those of skill will understand that details of the communications between printer 10′ and secure server 10-4 are not limitations of the present invention. Nor, are any encoding, encryption or hashing techniques used to protect the information transmitted from printer 10′, limitations of the present invention.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed:

1. A secure product comprising:
an identifier carrying member, the identifier having a sensible physical characteristic, the member having at least one region which carries applied information, and, a composite identifier formed of indicia of the physical characteristic and the applied information.

2. A product as in claim 1 where the member comprises a two dimensional document.

3. A product as in claim 2 where the physical characteristic comprises one of a unique magnetic, a unique optical or a unique radio frequency characteristic.

4. A product as in claim 3 where the document comprises one of a label, a license, a transportation ticket, an entertainment ticket, a real estate document, or a financial document.

5. A product as in claim 4 which includes at least one graphical element.

6. A document printer comprising:
control circuitry including a plurality of pre-stored executable instructions;
storage for variable document information;
a sensor of a physical document characteristic coupled to the circuitry;
the control circuitry including first instructions to combine variable document information with information pertaining to the physical characteristic of the document to form an authentication key, and an element, coupled to the circuitry, for recording the key on the document.

7. A printer as in claim 6 where the element comprises a print head.

8. A printer as in claim 6 where the first instructions carry out at least one of a logical function, a mathematical function, an encoding function, an encrypting function or a hash function.

9. A printer as in claim 6 which includes a second sensor of variable document information coupled to the control circuitry.

10. A printer as in claim 8 which includes a second sensor of variable document information coupled to the control circuitry.

11. A printer as in claim 10 where the first instructions combine variable information from the second sensor with information from the first sensor to form the authentication key.

12. A printer as in claim 7 which includes additional instructions for control of the element.

13. A printer as in claim 7 which includes instructions to receive variable document information, from a displaced source, via a computer network.

14. A printer as in claim 13 which includes instructions to transmit at least the key to a displaced location via the network.

15. A method comprising:
obtaining information associated with an existing product;
sensing a physical characteristic of a blank;
combining at least some of the information with at least a portion of the scanned physical characteristic to create an authentication indicium;
affixing the authentication indicium to the blank; and
associating the blank with the product.

16. A method as in claim 15 which includes printing the authentication indicium as well as other information on the blank.

17. A method as in claim 15 where associating comprises affixing the blank to at least one of the product or packaging for the product.

18. A method as in claim 15 where obtaining information comprises scanning an existing label carried by the product.

19. A method as in claim 18 where associating comprises affixing the blank to at least one of the product or packaging for the product.

20. A method as in claim 15 where the information includes at least one of a pre-applied bar code, locally provided information, or information obtained from a displaced location.

21. A method as in claim 20 which includes applying the authentication indicium and at least some of the other information, to the blank.

22. A method as in claim 15 where the information is represented, at least in party by a pre-applied code.

23. A method as in claim 22 which includes printing the authentication indicium and at least some of the other information, in the form of a code, on the blank.

24. A method as in claim 23 where the printing comprises printing in the form of a bar code.

25. A method as in claim 15 which includes forwarding at least some of the information and the authentication indicium to a remote location.

26. A method as in claim 25 which includes encrypting at least some of the information before forwarding same.

27. A method as in claim 25 where obtaining information includes receiving the information from at least one of off of the product, or, via a local manual entry.

28. A method as in claim 25 where obtaining information includes downloading at least part of the information from a remote source.

29. A method as in claim 15 where the sensing comprises sensing at least one of a magnetic characteristic, an optical characteristic or, a radio frequency activated characteristic.

30. A method comprising:
obtaining variable information for a document;
obtaining a physical characteristic of a blank for the document;
combining at least some of the variable information with a representation of at least a portion of the physical characteristic to form an authentication element;
incorporating the authentication element and at least part of the variable information into the blank to at least partly form the document.

31. A method as in claim 30 where obtaining includes at least one of accessing a pre-existing database, sensing another document, or manually providing at least some of the variable information.

32. A method as in claim 30 where obtaining the physicial characteristics includes sensing one of a magnetic member embedded in the blank, an optical characteristic of the blank, or an RFID tag, and forming a unique signature for the blank.

33. A method as in claim 32 where combining includes combining a representation of the physical characteristics with at least some of the variable information to form the authentication element.

34. A method as in claim 31 where obtaining the physical characteristics includes sensing one of a magnetic member embedded in the blank, an optical chracteristic of the blank, or an RFID tag, and forming a unique signature for the blank

35. A method as in claim 34 where combining includes combining the sensed characteristic with at least some of the variable information to form the authentication element.

36. A method as in claim 30 which includes forwarding at least one of the representation, the authentication element or some of the variable information, to a displaced location for storage.

37. A method as in claim 34 which includes scanning the physical characteristic of the document;
sensing the authentication element carried by the document;
sensing information carried by the document;
combining the scanned physical characteristic of the document with sensed information from the document to create an authentication key;
comparing the key to the element to determine document authenticity.

38. A method as in claim 37 which includes forwarding at least some of the key, the element or the information to a displaced location for evaluation.

39. A method as in claim 30 where the variable information is obtained from at least one of a displaced source, or a local data entry.
